(19) United States
(12) Patent Application Publication
(10) Pub. No.: US 2021/0031275 A1
(43) Pub. Date: Feb. 4, 2021

(54) ROTATING ELEMENT OPERATING DEVICE

(71) Applicant: Cheng-Hung YEN, TAICHUNG CITY (TW)

(72) Inventor: Cheng-Hung YEN, TAICHUNG CITY (TW)

(21) Appl. No.: 16/907,516

(22) Filed: Jun. 22, 2020

(30) Foreign Application Priority Data
Jul. 31, 2019 (TW) 108130655

(51) Int. Cl. B23B 31/28; B23B 31/10

(52) U.S. Cl. CPC B23B 31/28; B23B 2231/02; B23B 31/10

(57) ABSTRACT

A rotating element operating device includes a device body having a perforation, an operating member having a limiting end and an engaging end and being received in or extended out of the device body along the perforation, and a magnetic member set at the device body or the operating member. When the operating member is received in the device body, the magnetic force of the magnetic member pulls the operating member toward the bottom end of the device body so that the engaging end is set at the top end, and the operating member is secured to the device body by the magnetic force of the magnetic member. When the operating member is pulled out of the device body, the limiting end is positioned inside the perforation so that the operating member is prohibited from leaving the device body.

### BACKGROUND OF THE INVENTION

### 1. Field of the Invention

The present invention relates to tools and more particularly, to a rotating element operating device.

### 2. Description of the Related Art

Rotating elements are widely used in the mechanical field. For example, various types of rotating shafts and screws use rotation to achieve various functions such as combining components. The tools commonly used for rotating components are screwdrivers and wrenches. Users must bring various screwdrivers or wrenches to rotate the screws, which is very inconvenient to operate.

In order to more conveniently operate rotating elements, for example, the DE202015005799 patent discloses the technical content that the lever member can be extended out of or received in the shaft. However, the lever member of the above patent is prone to protrude from the outside of the shaft due to the action of external force, causing the problem of accidental contact or damage by collision.

### SUMMARY OF THE INVENTION

The present invention has been accomplished under the circumstances in view. It is the main object of the present invention to provide a rotating element operating device, which eliminates the need to prepare additional tools to easily operate the rotating element, and ensures that the component members will not protrude outside, reducing the problem of false touch or interference, and improving the quality and life of use.

To achieve this and other objects of the present invention, a rotating element operating device in accordance with the present invention comprises a device body, a magnetic member and an operating member, The device body comprises a top end, a bottom end, and a perforation extending from the top end toward the bottom end. The operating member comprises a limiting end and an engaging end. The operating member is received in or pulled out of the device body along the perforation. The magnetic member is mounted in at least one of the device body and the operating member. When the operating member is received in the device body, the magnetic force of the magnetic member pulls the operating member toward the bottom end of the device body, so that the engaging end is set at the top end, and the operating member is secured to the device body by the magnetic force of the magnetic member. When the operating member is pulled out of the device body, the limiting end is positioned inside the perforation so that the operating member is prohibited from leaving the device body. The constituent components of the present invention will not arbitrarily extend outside, reducing the problem of false touch or interference, and improving the quality and life of use.

Preferably, the device body further comprises an annular step protruding from an inner wall of the perforation near the top end. The inner diameter of the annular step is smaller than the inner diameter of the perforation.

Preferably, the engaging end comprises a disc body and a circumferential portion extended from the border edge of the disc body. When the operating member is received in the device body, the disc body and the circumferential portion are capped on the top end of the device body. Furthermore, the magnetic member is selectively set at the disc body or the circumferential portion.

Preferably, the bottom end of the device body is configured to detachably insert with a tool bit.

Preferably, the magnetic member is mounted in the perforation of the device body. The rotating element operating device further comprises a flexible cushion set between the magnetic member and the limiting end of the operating member. When the operating member and the magnetic member contact each other, the flexible cushion is disposed between the magnetic member and the operating member.

Preferably, when the operating member is received in the device body, the operating member is directly in contact with the magnetic member or separated from the magnetic member by a predetermined distance.

Preferably, the operating member is provided with an elastic washer. When the operating member is received in the device body, the elastic washer is positioned in a gap between the operating member and the device body.

Preferably, the engaging end of the operating member is provided with a positioning portion corresponding to the position of the top end of the device body. When the operating member is received in the device body, the positioning portion is engaged into a locating groove on the top end of the device body.

Preferably, the engaging end of the operating member is provided with an engaging portion for engaging the device body.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a schematic sectional elevational view of a rotating element operating device in accordance with a first embodiment of the present invention.

FIG. 2 is a sectional view of the rotating element operating device in accordance with the first embodiment of the present invention.

FIG. 3 is similar to FIG. 2, mainly showing the operating member pulled toward the bottom end by the magnetic force.

FIG. 4 is a sectional view of an alternate form of the rotating element operating device in accordance with the first embodiment of the present invention.

FIG. 5 is a schematic sectional elevational exploded view of a rotating element operating device in accordance with a second embodiment of the present invention.

FIG. 6 illustrates an alternate form of the engaging end of the operating member of the rotating element operating device in accordance with the second embodiment of the present invention.

FIG. 7 is an exploded view of a rotating element operating device in accordance with a third embodiment of the present invention.

FIG. 8 is a sectional view of the rotating element operating device in accordance with the third embodiment of the present invention.

FIG. 9 is a schematic sectional elevational view of a rotating element operating device in accordance with a fourth embodiment of the present invention.

### DETAILED DESCRIPTION OF THE INVENTION

The technical content and features of the present invention are described hereinafter with reference to the annexed drawings. The present invention can be widely applied to drive rotating elements of various forms or specifications, such as rotating shafts, screws and the like. Those skilled in the art can understand that the explanatory terms of the present preferred embodiment belong to a generic description that does not limit the application. For example, a material or shape term includes, without limitation, the material or shape specified by the description, and the positional terms include and are not limited to setting, approaching, connecting, or abutting. The quantity “a” of each component includes the number of one or more components. The directional expressions such as “upper”, “lower”, “inside”, “outside”, “top” and “bottom” mentioned in the contents of this specification are merely illustrative terms used in the normal direction of use, not intended to limit the meaning of the claim.

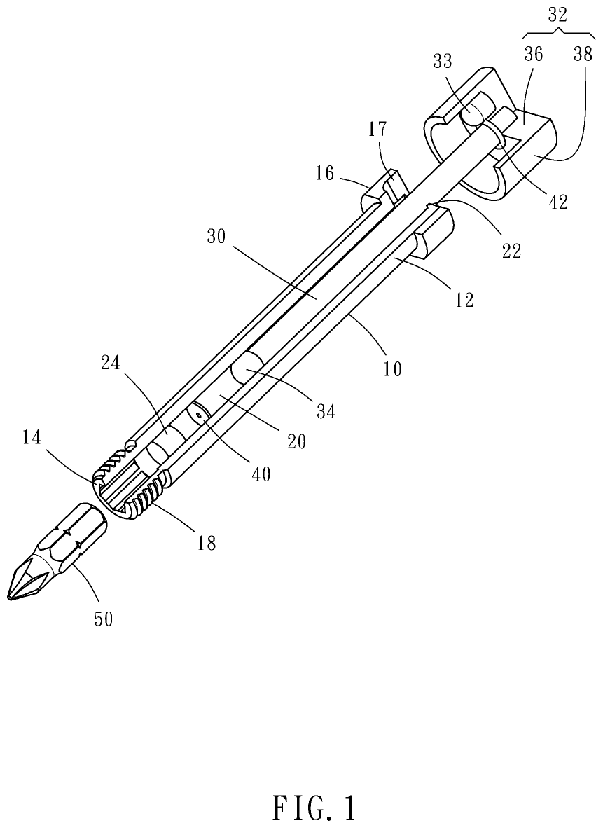

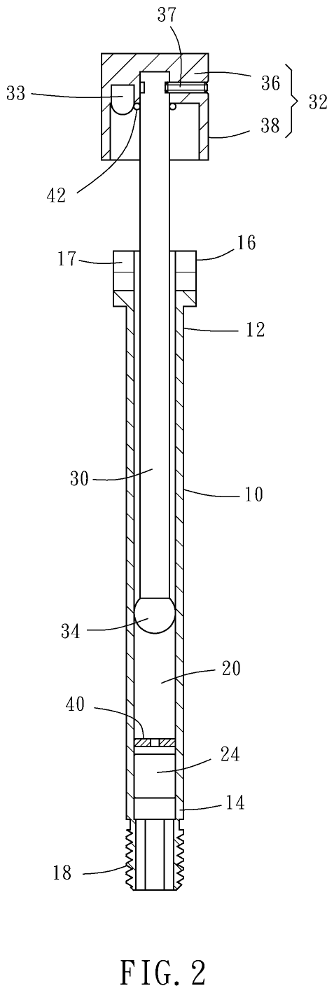

Referring to FIGS. 1-3, a rotating element operating device in accordance with a first embodiment of the present invention mainly comprises a device body 10 and an operating member 30. In this preferred embodiment, the device body 10 and the operating member 30 are selectively elongated as an example.

The device body 10 has a top end 12 and an opposing bottom end 14, a head 16 located at the top end 12, a threaded portion 18 located at the bottom end 14, a perforation 20 axially extended from the center of the top end 12 toward the bottom end 14 that may or may not penetrate the bottom end 14 depending on the application, and an annular step 22 protruding from the inner wall of the perforation 20 near the top end 12. The inner diameter of the annular step 22 is smaller than the inner diameter of the perforation 20.

In this preferred embodiment, the perforation 20 of the device body 10 is provided with a magnetic member 24 near the bottom end 14 as an example. The magnetic member 24 is a permanent magnet as an example. The magnetic member 24 may also be disposed on the operating member 30, or both the device body 10 and operating member 30 are respectively provided with a magnetic member 24.

The operating member 30 in this preferred embodiment is made of a magnetically conductive material such as steel. The operating member 30 has a limiting end 34 and an engaging end 32. In this preferred embodiment, the limiting end 34 takes a spherical shape as an example. The engaging end 32 has a disc body 36 and a circumferential portion 38 extended from the edge of the disc body 36. The disc body 36 is attached to the top end of the operating member 30 by a pin 37.

The operating member 30 is located on the device body 10 along the perforation 20. The limiting end 34 is located inside the perforation 20 of the device body 10 between the bottom end 14 and the annular step 22. The engaging end 32 is located outside the head 16 of the device body 10. The operating member 30 can be received inside the device body 10 or pulled out of the device body 10 along the perforation 20.

When the operating member 30 is received inside the device body 10, a magnetic force is generated between the operating member 30 and the magnetic member 24 to pull the operating member 30 toward the bottom end 14 of the device body 10 so that the operating member 30 can be secured to the device body 10 by the magnetic force to set the disc body 36 and circumferential portion 38 of the engaging end 32 around the head 16. When the operating member 30 is pulled out of the device body 10 with the limiting end 34 stopped at the annular step 22, since the diameter of the limiting end 34 is larger than the inner diameter of the annular step 22, the limiting end 34 can only be located inside the perforation 20 so that the operating member 30 will not leave the device body 10. At this time, the operating member 30 can use the limiting end 34 as a fulcrum to deflect with respect to the device body 10 until the operating member 30 is fitted into a locating groove 17 on the head 16, and then the operating member 30 can drive the device body 10 to rotate, thereby locking the threaded portion 18 of the bottom end 14 to a specific mechanism.

The present invention utilizes the above-mentioned components, and the operating member 30 can be pulled toward the bottom end 14 of the device body 10 at any time by the magnetic force generated by the magnetic member 24 inside the device body 10 to ensure that the operating member 30 does not protrude outside the device body 10 arbitrarily, avoiding problems of accidental touch or interference, and improving the quality and life of use. The device body 10 is equipped with the operating member 30 that can be pulled out or received. As long as the operating member 30 is directly or indirectly pulled out and positioned, the device body 10 can be rotated without using any other additional components such as screwdrivers or wrenches. The present invention is very convenient to use and can be applied to all application fields that require rotating elements, such as land, sea and air vehicles, construction engineering, packaging, machinery, furniture, fire-fighting, medical aids, etc. Moreover, the operating member 30 can be integrated inside the device body 10, and the structure is simple and compact, without increasing the volume and weight, and maintaining sufficient structural strength and locking force. The bottom end 14 of the device body 10 can also be detachably inserted with a tool bit 50, which makes the invention more practical and applicable.

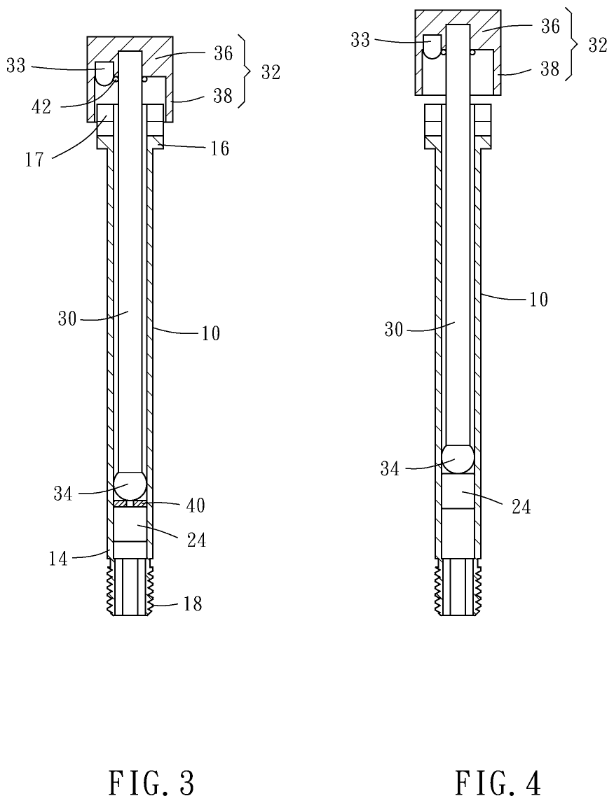

As shown in FIGS. 3 and 4, the operating member 30 and the magnetic member 24 can be in direct contact or separated by a predetermined distance, as long as there is sufficient magnetic force between the two. As shown in FIG. 3, a flexible cushion 40 can be added between the limiting end 34 of the magnetic member 24 and the operating member 30, so that the direct contact between the operating member 30 and the magnetic member 24 can reduce the impact sound. In addition, as shown in FIG. 1, the operating member 30 can be sleeved with an elastic washer 42. When the operating member 30 is received in the device body 10, using the elastic washer 42 to reduce the gap between the two can further reduce the vibration effect.

It is worth mentioning that, in order to increase the positioning effect between the operating member 30 and the device body 10, the engaging end 32 of the operating member 30 may be provided with a positioning portion 33, and the positioning portion 33 is located at the disc body 36 corresponding to the position of the head 16. The positioning portion 33 can be set in the locating groove 17 when the operating member 30 is received in the device body 10, thereby increasing the positioning between the operating member 30 and the device body 10.

As shown in FIG. 6, the circumferential portion 64 of the engaging end 62 of the operating member 60 can optionally be provided with an engaging portion 66, which further increases the torsion effect of the operating member 60 to drive the device body 70.

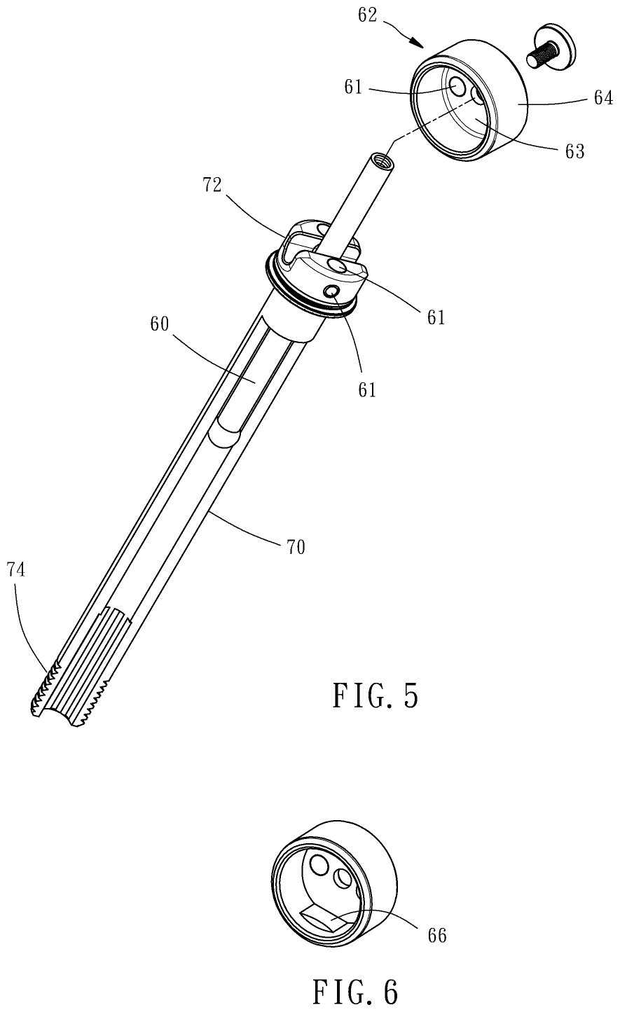

Furthermore, the magnetic member 61 can be mounted to the operating member 60. As shown in FIG. 5, the magnetic member 61 can be selectively set to the inner surface of the disc body 63 or the circumferential portion 64 of the engaging end 62 of the operating member 60. The magnetic member 61 can correspond to the top end 72 of the device body 70, allowing the magnetic force of the magnetic member 61 to pull the operating member 60 toward the bottom end 74 of the device body 70. Alternatively, the magnetic member 61 can be set at the top end 72 of the device body 70 corresponding to the position of the disc body 63 or the circumferential portion 64, and the magnetic force of the magnetic member 61 can also pull the operating member 60 to the bottom end 74 of the device body 70.

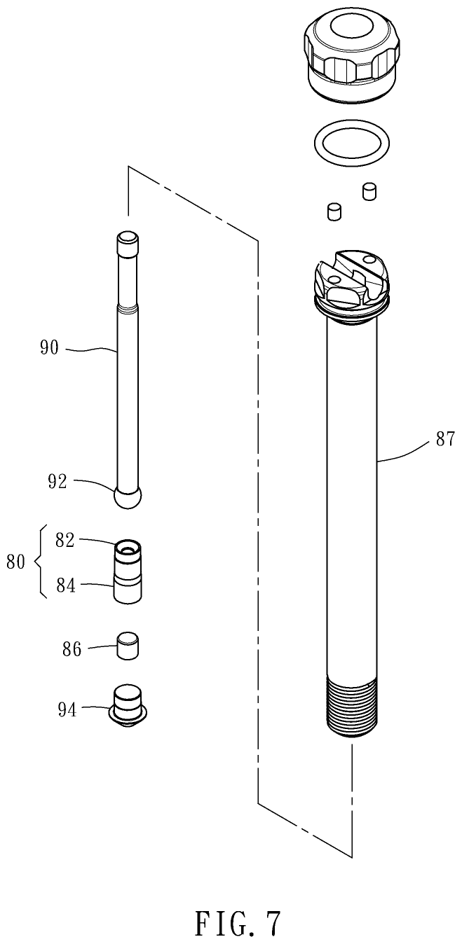

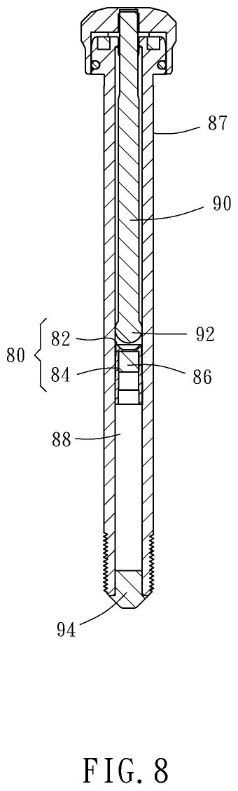

As shown in FIGS. 7 and 8, a rotating element operating device in accordance with a third embodiment of the present invention is provided. According to this third embodiment, the flexible cushion 80 has a circular top 82 and a side wall 84 ringed around the circular top 82; the device body 87 is provided with a plug 94 at the bottom end thereof. The circular top 82 of the flexible cushion 80 has a concave arc shape corresponding to the limiting end 92 of operating member 90. The side wall 84 is ring-shaped. The magnetic member 86 is mounted inside the side wall 84. The flexible cushion 80 is mounted in the perforation 88 of the device body 87 between the magnetic member 86 and the limiting end 92 of the operating member 90. Through the flexible cushion 80, the magnetic member 86 can be assembled synchronously inside the device body 87, facilitating fabrication and improving efficiency.

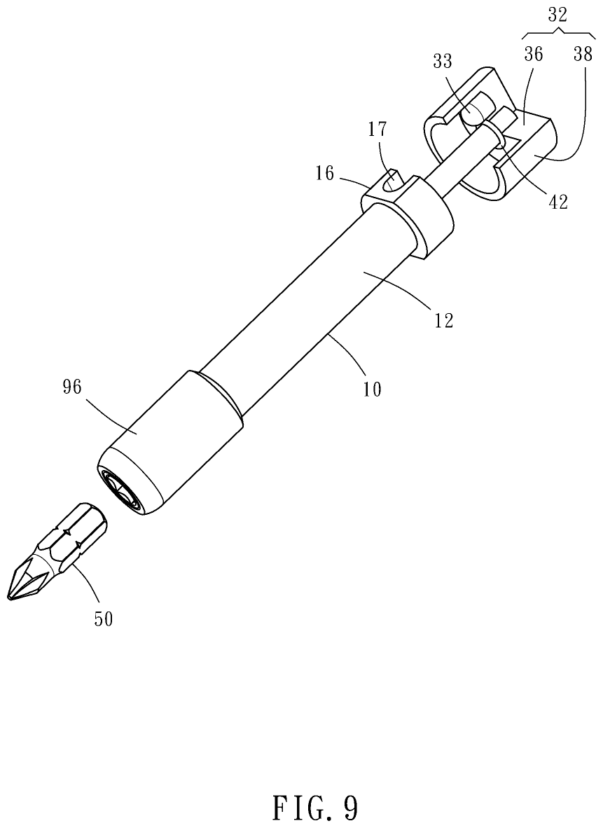

As shown in FIG. 9, a rotating element operating device in accordance with a fourth embodiment of the present invention is provided. According to this fourth embodiment, a quick release unit 96 is attached to the bottom end of the device body 10 for easy assembly and detachment of different size tool bit 50.

What is claimed is:

1. A rotating element operating device, comprising:
a device body comprising a top end, a bottom end and a perforation extending from said top end toward said bottom end;
an operating member comprising a limiting end and an engaging end, said operating member being received in or pulled out of said device body along said perforation; and
a magnetic member mounted in at least one of said device body and said operating member;
wherein when said operating member is received in said device body, the magnetic force of said magnetic member pulls said operating member toward said bottom end of said device body, so that said engaging end is set at said top end, and said operating member is secured to said device body by the magnetic force of said magnetic member; when said operating member is pulled out of said device body, said limiting end is positioned inside said perforation so that said operating member is prohibited from leaving said device body.

2. The rotating element operating device as claimed in claim 1, wherein said device body further comprises an annular step protruding from an inner wall of said perforation near said top end, the inner diameter of said annular step being smaller than the inner diameter of said perforation.

3. The rotating element operating device as claimed in claim 1, wherein said engaging end comprises a disc body and a circumferential portion extended from the border edge of said disc body, said disc body and said circumferential portion being capped on said top end of said device body when said operating member is received in said device body; said magnetic member is selectively set at said disc body or said circumferential portion.

4. The rotating element operating device as claimed in claim 1, wherein said bottom end of said device body is configured to detachably insert with a tool bit.

5. The rotating element operating device as claimed in claim 1, wherein said magnetic member is mounted in said perforation of said device body; the rotating element operating device further comprises a flexible cushion set between said magnetic member and said limiting end of said operating member, said flexible cushion being disposed between said magnetic member and said operating member when said operating member and said magnetic member contact each other.

6. The rotating element operating device as claimed in claim 5, wherein said flexible cushion comprises a top and a side wall ringed around the top of said flexible cushion; said magnetic member is mounted inside said side wall of said flexible cushion; said flexible cushion is mounted in said perforation of said device body with the top of said flexible cushion disposed between said magnetic member and said limiting end of said operating member.

7. The rotating element operating device as claimed in claim 1, wherein when said operating member is received in said device body, said operating member is directly in contact with said magnetic member or separated from said magnetic member by a predetermined distance.

8. The rotating element operating device as claimed in claim 1, wherein said operating member is provided with an elastic washer, said elastic washer being positioned in a gap between said operating member and said device body when said operating member is received in said device body.

9. The rotating element operating device as claimed in claim 1, wherein said engaging end of said operating member is provided with a positioning portion corresponding to the position of said top end of said device body, said positioning portion being engaged into a locating groove on said top end of said device body when said operating member is received in said device body.

10. The rotating element operating device as claimed in claim 1, wherein said engaging end of said operating member is provided with an engaging portion for engaging said device body.

11. The rotating element operating device as claimed in claim 1, wherein a quick release unit is attached to said bottom end of said device body.
